(19) United States
(12) Patent Application Publication
(10) Pub. No.: US 2013/0144699 A1
(43) Pub. Date: Jun. 6, 2013

(54) Method for Simplifying Use of Commercial Website Interfaces for Secure Customer Purchases

(71) Applicants: Jijo Xavier, Milpitas, CA (US); Mammen Thomas, Hercules, CA (US)

(72) Inventors: Jijo Xavier, Milpitas, CA (US); Mammen Thomas, Hercules, CA (US)

(21) Appl. No.: 13/310,487

(22) Filed: Dec. 2, 2011

(51) Int. Cl. G06Q 30/06; H04L 9/32; G06Q 30/02

(52) U.S. Cl. 705/14.23

(57) ABSTRACT

In one embodiment, a system comprises a server and a mobile device including a user agent. The mobile device is coupled to the server via a network. The user agent is included in the mobile device to perform common steps in an online purchase process for a user of the mobile device without requiring input from the user during the online purchase process. The common steps includes for instance: enabling a browser on the mobile device to capture a URL associated with a location based service (LBS) facility, inputting a sign-in information in a sign-in webpage using information stored on the mobile device, checking a product or service selected for purchase for an available discount code and inputting the available discount code, and inputting shipping and payment information in a shipping and payment webpage using information stored on the mobile device. Other embodiments are also described.

### FIELD

An embodiment of the invention relate generally to methods and systems for simplifying use of commercial website interfaces for secure customer purchases.

### BACKGROUND

Currently, online purchase process on a typical commercial website begins with the user typing in the Uniform Resource Locator (URL) of the website in the browser address bar. The website may display a login page followed by one or more pages where the user can browse through the service offerings and make selections. Once a selection is made by the user, a selection confirmation page followed by a payment page for the selected services will be presented for the user. Finally, a confirmation page will be displayed to the user, summarizing the services he or she purchased. Accordingly, many steps in the typical online purchase process require the user's input.

### SUMMARY

This invention implemented on a mobile device to reduce the number of steps in accessing a commonly used commercial website by securely automating a number of steps that are standard or common in the online purchase process.

In one embodiment of the invention, a system comprises a server and a mobile device that includes a user agent. The mobile device is coupled to the server via a network such as the Internet or a Cloud. The user agent is included in the mobile device to perform common steps in an online purchase process for a user of the mobile device without requiring input from the user during the online purchase process. The common steps includes for instance: (i) enabling a browser on the mobile device to capture a Uniform Resource Locator (URL) associated with a location based service (LBS) facility, (ii) inputting a sign-in information in a sign-in webpage using information stored on the mobile device, (iii) checking a product or service selected for purchase for an available discount code and inputting the available discount code, and (iv) inputting shipping and payment information in a shipping and payment webpage using information stored on the mobile device.

In another embodiment of the invention, a method of processing a user's online purchase starts with a user agent included on a mobile device recognizing a location based service (LBS) facility and enabling a browser to capture the Uniform Resource Locator (URL) of the LBS facility on the mobile device. A server receives the request for the URL and provides a sign-in webpage to the mobile device. The user agent inputs sign-in information in the sign-in webpage using the information that is pre-stored in the mobile device. Upon receiving the sign-in information from the user agent, the server verifies the identity of the user based on the sign-in information. Once the user identity is verified, the server 201 sends webpage components associated with the URL to the mobile device. Upon receiving a product or service selected by the user, the user agent checks the selected product or service for a discount code and inputs the discount code; and the user agent sends the selected product or service for purchase and the discount codes from the mobile device to the service.

The above summary does not include an exhaustive list of all aspects of the present invention. It is contemplated that the invention includes all systems, apparatuses and methods that can be practiced from all suitable combinations of the various aspects summarized above, as well as those disclosed in the Detailed Description below and particularly pointed out in the claims filed with the application. Such combinations may have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. In the drawings:

FIG. 1 shows a flow diagram of a method of processing a user's online purchase according to the prior art.

FIG. 2 shows a system in which one embodiment of the invention may be implemented.

FIG. 3 shows a sequence diagram of a method of processing a user's online purchase according to one embodiment of the invention.

### DETAILED DESCRIPTION

In the following description, numerous specific details are set forth. However, it is understood that embodiments of the invention may be practiced without these specific details. In other instances, well-known circuits, structures, and techniques have not been shown to avoid obscuring the understanding of this description.

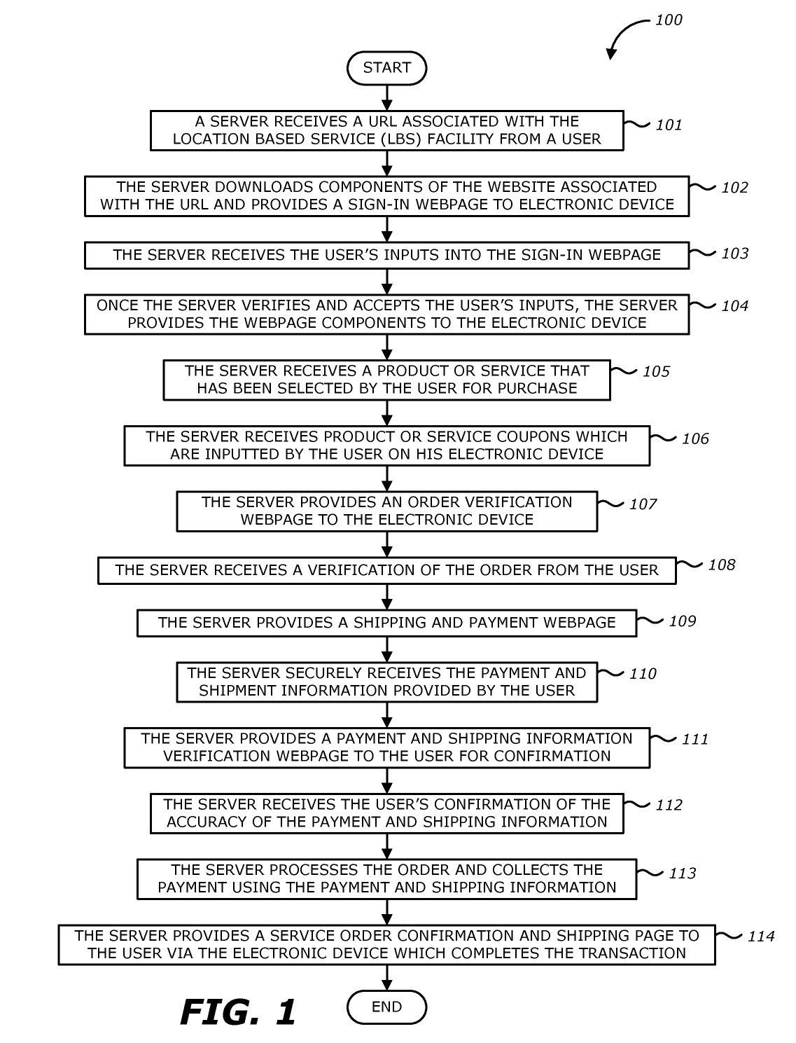

FIG. 1 shows a flow diagram of a method of processing a user's online purchase according to the prior art. The method 100 starts at Block S101, where a server receives a Uniform Resource Locator or Universal Resource Locator (URL) associated with the location based service (LBS) facility from a user. The user may input via a keyboard on an electronic device the desired URL.

At Block S102, upon receiving the URL which has been parsed by the browser, the server downloads components of the website associated with the URL and provides a sign-in webpage to electronic device. The sign-in webpage includes the sign-in page for existing clients and the registration page for new clients. In the registration page, new clients may input registration information such as their name, email address as well as username and password which the user is to create. In the sign-in page, existing clients may input sign-in information such as the username and the password that they have previously created using the registration page. The user's sign-in information or registration information identify the user to the server and the loyalty considerations that are associated with the user.

At Block S103, the server receives the user's inputs into the sign-in webpage which may include either sign-in information or registration information to be verified.

Once the server verifies and accepts the user's inputs, at Block S104, the server provides the webpage components to the electronic device so that the browser on the electronic device can display the webpage associated with the URL inputted by the user.

The server is now enabled to download additional web page components based on user request for display on the browser. This allows the user to search through and browse for any needed product and services.

At Block S105, the server receives a product or service that has been selected by the user for purchase. At Block S106, the server further receives product or service coupons which are inputted by the user on his electronic device.

At Block S107, the server provides an order verification webpage to the electronic device that allows the user to verify and accept or reject the products and services selected for purchase. At Block S108, the server receives a verification of the order from the user.

At Block S109, the server provides a shipping and payment webpage which contains shipping and payment information to be selected or completed by the user. The shipping information may include a type of shipment such as overnight delivery, standard mail etc. . . . The payment information may include the credit card information, the billing address, etc. . . .

At Block S110, the server securely receives the payment and shipment information provided by the user. At Block S111, the server provides a payment and shipping information verification webpage to the user for confirmation. The payment and shipping information verification webpage includes the payment and shipment information provided by the user as received by the server at Block S110. If there is no discrepancy in the information received, the user may confirm that the information is correct via the payment and shipping information verification webpage. At Block S112, the server receives the user's confirmation of the accuracy of the payment and shipping information. At Block S113, the server processes the order and collects the payment using the payment and shipping information. At Block S114, the server provides a service order confirmation and shipping page to the user via the electronic device which completes the transaction.

As shown in FIG. 1, the user required to provide information at many steps of the transaction. The Table 1 below lists the instances where the user is required to input information on the electronic device to the server in Method 100.

TABLE 1

| | Information provided by User via |
|---|---|
| Method 100 | input on the electronic device |
| Block S101: a server receives a URL | User inputs the URL |
| Block S103: the server receives the | User inputs either sign-in informa- |
| user's inputs into the sign-in web- | tion or registration information |
| page. | |
| Block S105: the server receives a | User selects product or service for |
| product or service that has been | purchase |
| selected by the user for purchase. | |
| Block S106: the server receives | User inputs product or services |
| product or services coupons | coupons |
| Block S108: the server receives a | User inputs verification of the |
| verification of the order from the | order |
| user. | |
| Block S110: the server securely | User inputs the payment and |
| receives the payment and shipment | shipment information. |
| information provided by the user | |
| Block S112: the server receives | User inputs verification of the |
| the user's confirmation of the | payment and shipping information. |
| accuracy of the payment and | |
| shipping information. | |

As shown in Table 1, at least seven steps in method 100 require the user's involvement. The intention of the user is to select the right service from services available and purchase it for the lowest price. As described in above, there are several steps that a user has to take in order to make a purchase. For an average user, most of the steps are typical and redundant. Most users also have preferred sites and they go to these same sites again and again. They never change their user name and seldom change passwords. The method of payment will also be by a common payment mechanism such as credit card, debit card etc. . . . Currently, users spend significant amount of their web access time on these redundant steps they have to go through to complete a service purchase. These steps in the rest of the document will be referred as common steps.

It will be ideal if the common steps that the user has to repeat to make any purchase can be securely automated to reduce the work effort of the user and make the web access and usage simple. This is especially true in the case of mobile web users who are on the go and have work on smaller mobile device screens of the mobile device, with limited time to go through a purchase.

The current invention implemented on a computing and display device (CDD) of the user, and especially a mobile user, reduces the number of steps in a accessing a commercial web site over the internet by securely automating the common steps. The invention is best suited for Location Based Service (LBS) on mobile computing and display units such as cell phones. Generally, mobile users do not want to spend time typing in redundant information or staring at the screen for the forms tom load. They want to get the task of access and common steps done in the shortest amount of time with minimum number of interaction.

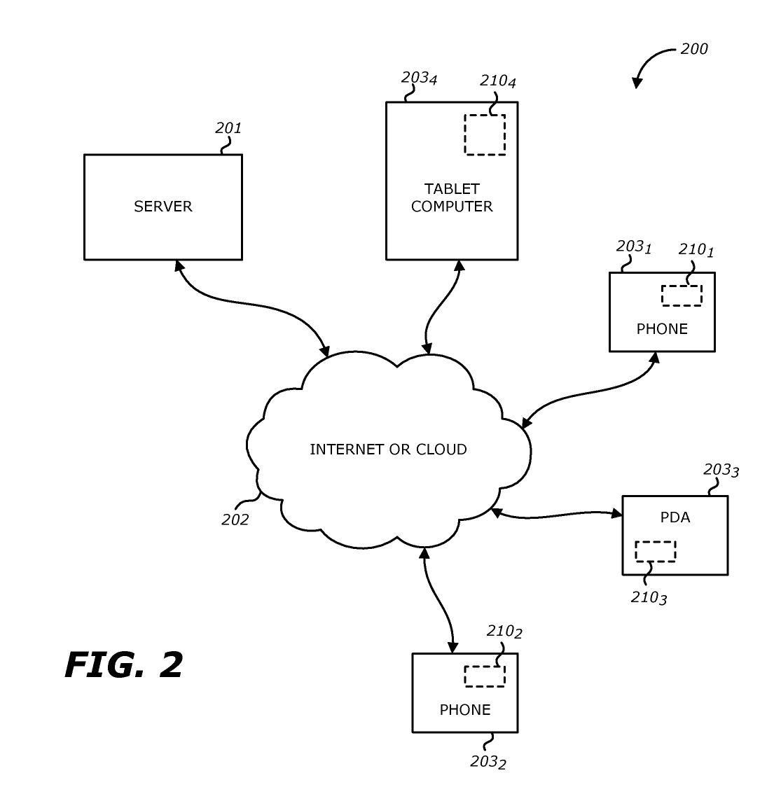

FIG. 2 shows a system in which one embodiment of the invention may be implemented. To reduce the number of steps in accessing a commercial web site over the Internet, one embodiment of the invention is implemented on a mobile device to securely automate a number of steps are considered standard in the online purchase process. In one embodiment of the invention, a location based service (LBS) is associated with a URL and the user accesses the URL via a mobile device.

The system 200 in FIG. 2 includes a commercial web server 201, the Internet or cloud 202 and a plurality of mobile devices 203₁-203ₙ. As shown in FIG. 2, the server 201 is coupled to the plurality of mobile devices 203₁-203₄ via the Internet 202. The server 201 may be a computer or computer application that delivers content through the Internet 202.

A mobile device may be a portable consumer electronic device. For instance, in FIG. 2, the mobile device 203₁, 203₂ are mobile cellular telephones, the mobile device 203₃ is a personal digital assistant (PDA), and the mobile device 203₄ is a tablet computer. It is understood that the system may also include stationary devices such as a stationary desktop computer. The mobile devices 203₁-203₄ may access the server 201 via the Internet 202. The mobile devices 203₁-203₄ may connect to the Internet 202 via transmission mediums such as wireless network connections. The user may also access the server 201 through a second secure and trusted web site on the mobile devices 203₁-203₄.

As shown in FIG. 2, each of the mobile devices 203₁-203₄ may include a user agent 210₁-210₄ which includes an application program that runs on the mobile devices 203₁-203₄. In some embodiments, in contrast to the standard HTTP/HTML browser client, the user agent 210₁-210₄ is an intelligent application program that identifies and automates the common steps included in the online purchase process. In other embodiments, the user may select the level of automation desired to be performed by the user agent 210₁-210₄. For instance, the user may limit the automatic completion of the payment and shipment information for security reasons or the user may provide specific access requirements. In some embodiments, the user agent 210₁-210₄ may appear, from the user's perspective, to be an application that acts as a web browser used to access the web server 201.

In one embodiment, the user agent 210₁-210₄ may have the capability to discover a website and a service without having the user to type-in the URL when a user enters the system 200. To this end the web server 201 announces (e.g., broadcasts or transmits to the mobile devices 203₁-203₄) the server's service interfaces in a specific format. The format may be called: service announcement data or service description data. The user agent 210₁-210₄ receives the service description data (i) from a publicly available server over a standard network, based on the location of the user, (ii) from broadcasted data transmitted over a standard broadcasting protocol such as UDP, (iii) from a previously loaded data file which contains the service description data for a given location, (iv) through a special protocol handler that is capable of receiving service description data from another application.

In some embodiments, the service description data describes how the common steps can be performed on the processor on the user's mobile device. The user agent 210₁-210₄ parses the service announcement data to process the semantics. The user agent 210₁-210₄ also displays the service announcement data in a human-readable form to the user via the mobile devices 203₁-203₄ so that the user is enabled to view the details of the available service and input required fields on the mobile device. Typically, the common steps will require the user's profile information such as login name, address, phone number, etc. . . . This profile information may be stored locally on the mobile device 203₁-203₄. Accordingly, the user agent 210₁-210₄ may retrieve the registration information from the device's local storage. Once the information is available thereon, the user agent 210₁-210₄ may use this information to automate the common steps and thereby minimizing the user's input.

The service announcement data is typically represented in a standard markup format. In the example that follows, this service announcement data is represented in XML format. Structure of the XML will include, but not limited to the following fields.

[LISTING1] Service Announcement Data

```
<service version=”1.0”>
  <profile name=”PoPularRetailStore” title=”Popular Retail Store”>
    <location href=”http://192.168.1.100/LBSWeb/index.html” />
    <icon href=”https://192.168.1.100/favicon.ico” />
    <description>
```

Popular Retail Store offers Location Based Service to access the store inventory and allows the users to check out items using their mobile devices.

```
  </description>
  <certificates>
    <certificate index=”1”>
      XXX intermediate certificate 1 body XXX
    </certificate>
    <certificate index=”2”>
      XXX intermediate certificate body XXX
    </certificate>
    <certificate index=”3”>
      XXX server certificate body XXX
    </certificate>
  </certificates>
</profile>
  <interface>
    <inputs>
      <form name=”login” display=”User Login” confirmation=”login_confirm”>
        <input type=”text” name=”loyalty_number” display=”Loyalty Number” />
        <input type=”password” name=”password” display=”Password” />
      </form>
      <form name=”payment” display=”Make Payment”
confirmation=”payment_confirmation”>
        <input type=”text” name=”creditcard_number” display=”CC Number” />
        <input type=”text” name=”expiry_date” display=”Exp date(YY/MM/DD)” />
      </form>
    </inputs>
  </interface>
</service>
```

As depicted in [LISTING1] above, the profile section and the interface section are two major parts in the service announcement data provided by the server 201.

The profile section provides the user agent 210₁-210₄ a means to establish the identity of the service. The typical profile section is described herein. The identity, among other information will include a unique string to identify the service instance. This may be a GUIDE or a plain string. The user agent 210₁-210₄ running on the mobile device 203₁-203₄ and using the mobile device's 203₁-203₄ processing power runs a discovery process during the initial contact to the service announcement data to identify the service. The server 201 uses this unique string (ID) to distinguish this service instance from others. This ID is typically created at the time of server 201 deployment and is not expected to change during the lifetime of the server 201. In the event that a new server having a new ID were to replace the server 201, the user agents 210₁-210₄ will not be able to communicate with the new server until it runs the discovery process again.

The title attribute is a human readable string which can be displayed to the user. This will typically be the common name of the service. The location attribute provides the entry point to the service. The user agent 210₁-210₄ may use this URL associated with the service to connect to the service. This is typically the base URL of the website.

The icon attribute points to a small icon representing the service. Once initial discovery and connection is established, this icon is displayed to the user on the mobile device 203₁-203₄. In some embodiments, this icon is displayed every time the service entry is recognized by the user agent 210₁-210₄ on the mobile device 203₁-203₄.

The description attribute provides a brief description of the services in a human readable text. The text is displayed to the user when displaying the service entry is accepted.

The certificate section of the structure contains the trust chain of the server 201. The user agent 210₁-210₄ uses the chain of certificates to verify whether the server is trusted by the user. The user agent 210₁-210₄ will have a set of trusted root certificates against which it checks the certificates available to ensure the trust worthiness of the site.

Hence, with the information provided in the profile section, the user agent application running on the mobile device 203₁-203₄ and using its processing power is able to identify the server 201 and present a brief description of the service interfaces to the user on the mobile device 203₁-203₄.

The interface section establishes how the website will interact with the user. The description of a typical interface section that follows and it provides all the forms and input fields related to the common steps described in this section. Input fields of the forms all have identifiers (ids) and human readable text for display.

After receiving the announcement data and before user visits the site, the user will have more opportunities to supply the values for input fields specified in the announcement data of a full user profile with all information that is not available and securely stored on the user's mobile device 203₁-203₄. The user agent 210₁-210₄ uses the display fields specified in the announcement data to present the input fields to the user when relevant data is unavailable. This gives the user an option to review the authenticity of the site and correlate the information with other saved service data. Once the user confirms the input data, the user agent 210₁-210₄ is ready for accessing the site and automating the common steps. Alternatively, the user profile is established as the user goes through the service choice, selection and payment first time.

Another important field of the interface is the confirmation attribute which tells the user agent 210₁-210₄ where to look for a confirmation data when a form submission succeeds. The returned value points to a section of the display (such as a <div> section). The server 201 will include a unique data in the section such as a confirmation number indicating that the process is complete. The user agent 210₁-210₄ automatically saves this data within a secure storage section for follow up and future reference.

The user agent 210₁-210₄ typically is a “closed” boundary application which means that the application does not allow the user to browse to any other site. The user starts from an already saved service or a newly discovered service, and browse inside that server. When the user agent receives a page, it checks the page contents for any known input fields and forms. If it finds a match, those fields will be auto-filled by the values given by the user in his profile.

The advantage of this method is that a commercial website can securely advertise its common steps and interfaces, establish trust and a working model with the users of mobile devices. All these can be achieved without any changes in the server deployment.

The following embodiments of the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a procedure, etc.

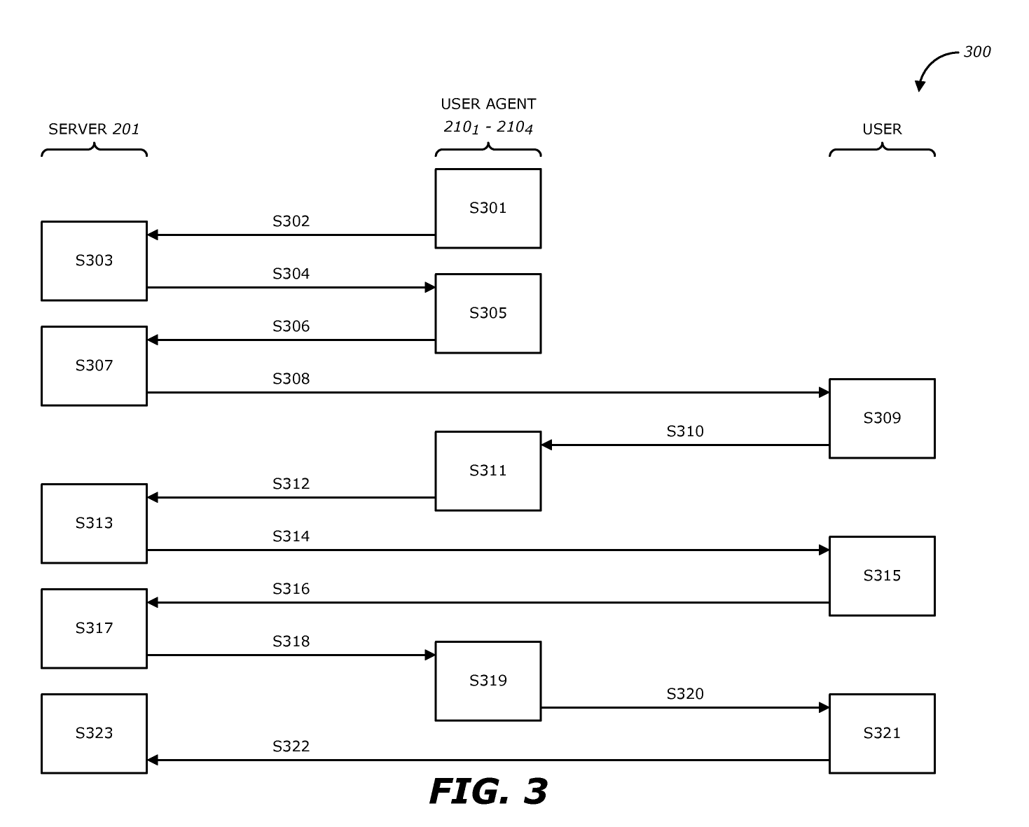

FIG. 3 shows a sequence diagram of a method of processing a user's online purchase according to one embodiment of the invention. As illustrated in FIG. 3, in one embodiment, the server 201 is coupled to the user agent 210₁-210₄ included on a mobile device 203₁-203₄. Further, the user interacts with the server 201 via the user agent 210₁-210₄ on the user's mobile device 203₁-203₄.

Method 300 begins at Block S301 when a user enters a service facility, where web-based LBS is available, the user agent 210₁-210₄ on the mobile device 203₁-203₄ recognizes the LBS and enables the browser to capture the URL of the LBS facility on the mobile device 203₁-203₄. In some embodiments, the connection to the user's mobile device 203₁-203₄ from the service facility may be established (i) by a network using UDP, (ii) by connection to an authenticated and secured server, or (iii) through a second trusted web site trusted by the user.

At Block S302, once the browser that was enabled by user agent 210₁-210₄ parses the URL, the browser sends request to the web server 201 for the webpage associated with the URL. At Block S303, the server 201 downloads the components of the web page associated with the URL received. In some embodiments, the components of the webpage include the sign-in webpage. The sign-in webpage may include the sign-in page for existing clients and the registration page for new clients. At Block S304, the server 201 provides the sign-in webpage to the mobile device 203₁-203₄.

At Block S305, the user agent 210₁-210₄ completes the necessary sign-in information required to be input in the sign-in webpage using the information that is pre-stored in the mobile device 203₁-203₄. In some embodiments, the user's sign-in information identifies the user as well as the loyalty considerations that are associated with the user to the server 201 and the service facility.

At Block S306, the user agent 210₁-210₄ sends the completed sign-in information from the mobile device 203₁-203₄ back to the server 201. At Block S307, the server 201 verifies the identity of the user based on the completed sign-in information. Once the user identity is verified, at Block S308, the server 201 sends the webpage components associated with the URL such that the browser on the mobile device 203₁-203₄ can display the web page.

The server 201 is now enabled to download additional web page components based on user request for display on the browser. This allows the user to search through and browse for any needed product and services. For instance, if the user is browsing through the shoes that are on sale on the webpage, the server will load each webpages associated to the shoes that the user has selected for detailed viewing.

At Block S309, the user selects a product or service for purchase on the webpage and at Block S310, the selected product or service is sent to the user agent 210₁-210₄. At Block S311, the user agent 210₁-210₄ automatically checks the selected product or service and inputs the available discount codes. The discount codes may be coupon codes that provide for cost reductions on the product or service. The discount codes may also be loyalty program codes which provide for additional loyalty points to a user's loyalty program.

At Block S312, the user agent 210₁-210₄ sends the selected product or service for purchase and the discount codes from the mobile device 203₁-203₄ to the server 201. At Block S313, the server 201 downloads an order verification page that allows the user to verify that the given product or service was selected for purchase. At Block S314, the server 201 sends the order verification page to the mobile device 203₁-203₄. At Block S315, the user verifies that the selected product or service is accurate. The user may accept or reject the product or service selected for purchase. If the user accepts the selected product or service being accurate, the user may confirm the order on the mobile device 203₁-203₄. If the user confirms that the selected product or service is accurate, the user's confirmation is sent to the server 201 at Block S316. At Block S317, the server 201 receives the user's verification of the order from the mobile device 203₁-203₄.

At Block S317, the server 201 downloads a shipping and payment webpage which contains shipping and payment information to be selected or completed. The shipping information may include a type of shipment such as overnight delivery, standard mail etc. . . . The payment information may include the credit card information, the billing address, etc. . . . At Block S318, the server 201 provides a shipping and payment webpage to the mobile device 203₁-203₄. At Block S319, the user agent 210₁-210₄ inputs the shipping and payment information into the shipping and payment webpage based on information that is pre-stored on the mobile device 203₁-203₄ and at Block S320, the completed shipping and payment webpage is presented to the user. At Block S321, if there is no discrepancy in the shipping and payment information received, the user confirms that the information is correct and at Block S322, sends the completed shipping and payment information webpage securely back to the web server 201. At Block S323, the server processes the order and collects the payment using the payment and shipping information for acceptance of the order and collection of payment and at Block S324, provides a service order confirmation and shipping page to the mobile device 203₁-203₄ which completes the transaction.

Accordingly, as shown in FIG. 3, the user agent 210₁-210₄ automatically performs the common steps in lieu of requiring input from the user. For instance, the user agent 210₁-210₄ performs the common steps listed included in Table 2.

TABLE 2

| | |
|---|---|
| Block | User agent 210₁-210₄ recognizes the LBS and enables the browser |
| S301 | to capture the URL of the LBS facility on the mobile device |
| | 203₁-203₄ |
| Block | User agent 210₁-210₄ completes the sign-in information in the |
| S305 | sign-in webpage |
| Block | User agent 210₁-210₄ automatically checks the selected product or |
| S311 | service for available discount codes and inputs the available |
| | discount codes. |
| Block | User agent 210₁-210₄ inputs the shipping and payment information |
| S319 | in the shipping and payment webpage |

As further delineated in FIG. 3, in this embodiment, the lesser number of steps require user inputs on the mobile device 203₁-203₄ to complete the online purchase. Table 3 compares the number of steps that require user inputs in the prior art method illustrated in FIG. 1 with the number of steps that require user inputs in the embodiment of the invention illustrated in FIG. 3.

TABLE 3

| | Embodiment of the Invention |
|---|---|
| Prior Art in FIG. 1 | in FIG. 3 |
| User inputs the URL | — |
| User inputs either sign-in information | — |
| or registration information | |
| User selects product or service for | Block S309: User selects product |
| purchase | or service for purchase |
| User inputs product or services | — |
| coupons | |
| User inputs verification of the order | Block S315: User confirms that the |
| | selected product is accurate |
| User inputs the payment and | — |
| shipment information. | |
| User inputs verification of the | Block S322: User sends the com- |
| payment and shipping information. | pleted shipping and payment |
| | information webpage |

As shown in Table 3, the number of steps that require the input of a user is reduced to three steps in the embodiment of the invention illustrated in FIG. 3 by using the user agent 210₁-210₄ to perform a number of steps that involve common steps. As discussed above, the user agent 210₁-210₄ may perform these common steps using the information stored in the mobile device 203₁-203₄.

It is understood that one of the major concerns about any automation is security of user data. The loss of private data and being exposed to identity theft due to the automation of certain steps may be a concern for the user. However, embodiments of the present invention may implement high security methods to mitigate these security risks. For instance, the information that is stored on the mobile device may be encrypted with a password that is chosen by the user to protect his profile. Additionally, the communication between the server and the user application on mobile device may be secured using PPK or other security protocols available to ensure that data being transferred is not tampered with.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

1. A system comprising:
a server; and
a mobile device coupled to the server via a network, the mobile device including a user agent,
wherein the user agent performs common steps in an online purchase process for a user of the mobile device without requiring input from the user to perform the common steps in the online purchase process, the common steps including:
enabling a browser on the mobile device to capture a Uniform Resource Locator (URL) associated with a location based service (LBS) facility when the user agent detects that the mobile device is in proximity of the LBS facility,
inputting a sign-in information in a sign-in webpage using information stored on the mobile device,
checking a product or service selected for purchase for an available discount code and inputting the available discount code, and
inputting shipping and payment information in a shipping and payment webpage using information stored on the mobile device.

2. The system of claim 1, wherein the network is the Internet or a Cloud, and the mobile device is connected to the network wirelessly.

3. The system of claim 1, wherein the server is a webserver that
downloads components of a webpage associated with the URL,
provides the sign-in webpage to the mobile device,
receives the sign-in information from the user agent and verifies that the sign-in information is valid,
if the sign-in information is valid, provides the components of a webpage associated with the URL to the mobile device.

4. The system of claim 3, wherein the webserver further
receives a product or service that has been selected by the user for purchase,
receives the discount code from the user agent,
provides an order verification webpage to the user,
receives an order confirmation from the user,
downloads and provides the a-shipping and payment webpage which contains the shipping and payment information to be completed to the user agent, and
receives the completed shipping and payment webpage.

5. The system of claim 1, wherein the user agent enables a browser on the mobile device to capture a URL associated with the LBS facility by:
using a service announcement data received from at least one of: (i) a publicly available server over a standard network, based on the location of the user, (ii) broadcasted data transmitted over a standard broadcasting protocol, (iii) a previously loaded data file that contains the service description data for a given location, (iv) a special protocol handler that is capable of receiving service description data from another application.

6. The system of claim 5, wherein the service announcement data includes a profile section and an interface section.

7. The system of claim 6, wherein the profile section provides the user agent a means to establish the identity of the service.

8. The system of claim 6, wherein the interface section establishes how the website will interact with the user by defining forms and input fields included in the website.

9. A method of processing a user's online purchase comprising:
a user agent included on a mobile device recognizing a location based service (LBS) facility and enabling a browser to capture the Uniform Resource Locator (URL) of the LBS facility on the mobile device when the user agent detects that the mobile device is in proximity of the LBS facility;
a server receiving the request for the URL and providing a sign-in webpage to the mobile device;
the user agent inputs sign-in information in the sign-in webpage using the information that is pre-stored in the mobile device;
upon receiving the sign-in information from the user agent, the server verifies the identity of the user based on the sign-in information;
once the user identity is verified, the server 201 sends webpage components associated with the URL to the mobile device; and
upon receiving a product or service selected by the user, the user agent checks the selected product or service for a discount code and inputs the discount code; and
the user agent sends the selected product or service for purchase and the discount codes from the mobile device to the service,
wherein without requiring input from the user, the user agent recognizes the LBS facility, enables the browser, inputs the sign-in information, and sends the selected product or service for purchase and the discount codes.

10. The method of claim 9, further comprising:
the server downloading and sending to the mobile device an order verification page that allows for verification that the given product or service was selected for purchase, and
the server receiving a confirmation on the order verification page from the user,

11. The method of claim 10, further comprising:
the server downloading and sending to the mobile device a shipping and payment webpage which contains shipping and payment information;
the user agent inputs, without input from the user, the shipping and payment information into the shipping and payment webpage based on information that is pre-stored on the mobile device;
the user agent sends, without input from the user, the shipping and payment webpage including shipping and payment information to the user;
the server receiving confirmation from the user that the shipping and payment information is correct.

12. The method of claim 9, wherein a connection to the user's mobile device from the service facility may be established (i) by a network using UDP, (ii) by connection to an authenticated and secured server, or (iii) through a second trusted web site trusted by the user.

13. The method of claim 9, further comprising the server downloading the components of the webpage associated with the URL, the components of the webpage including the sign-in webpage.

14. The method of claim 9, wherein the user's sign-in information identifies the user as well as the loyalty considerations associated with the user to the server and the LBS facility.

15. The method of claim 9, wherein the discount code may be at least one of: a coupon code that provides for cost reductions on the product or service and a loyalty program code that provides for additional loyalty points to a user's loyalty program.

16. The method of claim 9, wherein the user agent enables a browser on the mobile device to capture a URL associated with the LBS facility by:
using a service announcement data received from at least one of: (i) a publicly available server over a standard network, based on the location of the user, (ii) broadcasted data transmitted over a standard broadcasting protocol, (iii) a previously loaded data file that contains the service description data for a given location, (iv) a special protocol handler that is capable of receiving service description data from another application.

17. The method of claim 9, wherein the service announcement data includes a profile section and an interface section.

18. The method of claim 17, wherein the profile section provides the user agent a means to establish the identity of the service.

19. The method of claim 17, wherein the interface section establishes how the website will interact with the user by defining forms and input fields included in the website.
